(19) United States
(12) Patent Application Publication
(10) Pub. No.: US 2022/0104075 A1
(43) Pub. Date: Mar. 31, 2022

(54) PDU SESSION ESTABLISHMENT ACCEPT HANDLING FOR MA PDU SESSIONS

(71) Applicant: MEDIA TEK INC., Hsin-Chu (TW)

(72) Inventors: Yuan-Chieh Lin, Hsin-Chu (TW); Chien-Chun Huang-Fu, Hsin-Chu (TW); Chia-Lin Lai, Hsin-Chu (TW)

(21) Appl. No.: 17/471,843

(22) Filed: Sep. 10, 2021

Related U.S. Application Data
(60) Provisional application No. 63/085,322, filed on Sep. 30, 2020.

(51) Int. Cl. H04W 28/24; H04W 28/02; H04W 76/10; H04W 60/04

(52) U.S. Cl. CPC H04W 28/24; H04W 60/04; H04W 76/10; H04W 28/0268

(57) ABSTRACT

A method of handling multi-access (MA) Protocol data unit (PDU) session establishment procedure with multiple PDU SESSION ESTABLISHMENT ACCEPT messages by a UE is proposed. In one novel aspect, upon receiving a second PDU SESSION ESTABLISHMENT ACCEPT message over the other access, the UE deletes the stored authorized QoS rules, and deletes the stored authorized QoS flow descriptions and the stored mapped EPS bearer contexts if they are included in the PDU SESSION ESTABLISHMENT ACCEPT message. In another novel aspect, upon receiving a second PDU SESSION ESTABLISHMENT ACCEPT message over the other access, the UE performs a local release of the MA PDU session if any value of the selected PDU session type, selected SSC mode, 5GSM cause, PDU address, S-NSSAI, DNN IEs in the PDU SESSION ESTABLISHMENT ACCEPT message is different from the corresponding stored value.

### CROSS REFERENCE TO RELATED APPLICATIONS

This application claims priority under 35 U.S.C. § 119 from U.S. Provisional Application No. 63/085,322, entitled “PDU Session Establishment Accept Handling for MA PDU Sessions”, filed on Sep. 30, 2020, the subject matter of which is incorporated herein by reference.

### TECHNICAL FIELD

The disclosed embodiments relate generally to wireless communication, and, more particularly, to method of handling of Multi-Access (MA) PDU session establishment with multiple accept messages.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The Next Generation Mobile Network (NMN) board, has decided to focus the future NGMN activities on defining the end-to-end requirements for 5G new radio (NR) systems.

In 5G/NR, a Protocol Data Unit (PDU) session defines the association between the UE and the data network that provides a PDU connectivity service. The PDU session establishment is a parallel procedure of PDN connection (bearer) procedure in 4G/LTE. Each PDU session. is identified by a PDU session ID (PSI), and may include multiple QoS flows and QoS rules. Each PDU session can be established via a 5G Access Network (e.g., a 3GPP radio access network (RAN), or a non-3GPP RAN). The network/UE can initiate different PDU session procedures, e.g., PDU session establishment, PDU session modification, and PDU session release.

Operators are seeking ways to balance data traffic between mobile cellular networks and non-3GPP access in a way that is transparent to users and reduces mobile network congestion. In 5GS, UEs that can be simultaneously connected to both 3GPP access and non-3GPP access (using 3GPP NAS signalling), thus the 5GS is able to take advantage of these multiple accesses to improve the user experience, optimize the traffic distribution across various accesses. Accordingly, 3GPP introduced Multi-Access (MA) PDU session in 5GS. A MA PDU session uses one 3GPP access network or one non-3GPP access network at a time, or simultaneously one 3GPP access network and one non-3GPP access network.

In addition, ATSSS (Access Traffic Steering, Switching, Splitting) is an optional feature that can be supported by the UE and the 5GC network to route data traffic across 3GPP access and non-3GPP access networks for the established MA PDU session. An ATSSS capable UE establishes an MA PDU session supporting multi-access connectivity over 3GPP access and non-3GPP access networks. At any given time, the MA PDU session can have user-plane resources established on both 3GPP access and non-3GPP access, or on one access only (either 3GPP access or non-3GPP access).

For an MA PDU session establishment, if the UE is registered over both 3GPP access and non-3GPP access in different PLMNs, then the UE shall initiate the UE-requested PDU session establishment procedure over 3GPP access and non-3GPP access sequentially. Therefore, it is possible that the UE may receive more than one PDU SESSION ESTABLISHMENT ACCEPT messages during the life time of an MA PDU session. For example, the UE may receive two PDU SESSION ESTABLISHMENT ACCEPT messages including the ATSSS container IE over 3GPP access and non-3GPP access. It is undefined on the UE handling upon receiving the multiple ATSSS container IEs during the PDU session establishment for the same MA PDU.

A solution is sought.

### SUMMARY

A method of handling multi-access (MA) Protocol data unit (PDU) session establishment procedure with multiple PDU SESSION ESTABLISHMENT ACCEPT messages by a UE is proposed. In one novel aspect, for an MA PDU session already established on a single access, upon receipt of PDU SESSION ESTABLISHMENT ACCEPT message over the other access, the UE shall 1) delete the stored authorized QoS rules; 2) delete the stored authorized QoS flow descriptions if the authorized QoS flow descriptions IE is included in the PDU SESSION ESTABLISHMENT ACCEPT message; and 3) delete the stored mapped EPS bearer contexts if the mapped EPS bearer contexts IE is included in the PDU SESSION ESTABLISHMENT ACCEPT message. In another novel aspect, for an MA PDU session already established on a single access, upon receipt of a PDU SESSION ESTABLISHMENT ACCEPT message over the other access, the UE shall perform a local release of the MA PDU session if any value of the selected PDU session type, selected SSC mode, 5GSM cause, PDU address, S-NSSAI, DNN IEs in the PDU SESSION ESTABLISHMENT ACCEPT message is different from the corresponding stored value. The UE also performs a registration procedure for mobility and periodic registration update with REGISTRATION REQUEST messages including a PDU session status IE that is sent over both accesses.

In one embodiment, a UE maintains a multi-access protocol data unit (MA PDU) session and user plane resources on a first access type. The UE stores authorized QoS rules for the MA PDU session. The UE transmits a PDU session establishment request message over a second access type and in response receiving a PDU session establishment accept message. The UE deletes the stored QoS rules in response to the receiving the accept message. The UE establishes user plane resources on the second access type for the MA PDU, wherein the UE stores new authorized QoS rules carried by the PDU session establishment accept message.

In another embodiment, a UE maintains a multi-access protocol data unit (MA PDU) session and user plane resources on a first access type. The UE stores a first set of parameters for the MA PDU. The UE transmits a PDU session establishment request message over a second access type and in response receiving a PDU session establishment accept message. The UE determines a second set of parameters carried by the PDU session establishment accept message, wherein at least one parameter in the second set is different from a corresponding parameter in the first set. In response, the UE locally releases the MA PDU session and transmitting two REGISTRATION REQUEST messages. Each REGISTRATION REQUEST message includes a PDU session status information element (IE) to synchronize a MA PDU session status with the network, a first REGISTRATION REQUEST is sent over 3GPP access, and a second REGISTRATION REQUEST is sent over non-3GPP access.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G network supporting handling multiple accept messages for a Multi-Access Protocol Data Unit (MA PDU) session establishment in accordance with one novel aspect.

FIG. 2 illustrates simplified block diagrams of a user equipment (UE) and a network entity in accordance with embodiments of the current invention.

FIG. 3 illustrates a first embodiment of handling a second accept message by a UE for an MA PDU session establishment.

FIG. 4 illustrates a second embodiment of handling a second accept message by a UE for an MA PDU session establishment.

FIG. 5 is a flow chart of a method of handling multi-access (MA) Protocol data unit (PDU) session establishment with multiple accept messages in accordance with one novel aspect.

FIG. 6 is a flow chart of a method of handling multi-access (MA) Protocol data unit (PDU) session establishment with multiple accept messages in accordance with one novel aspect.

### DETAILED DESCRIPTION

Reference will now be made in detail to some embodiments of the invention, examples of which are illustrated in the accompanying drawings.

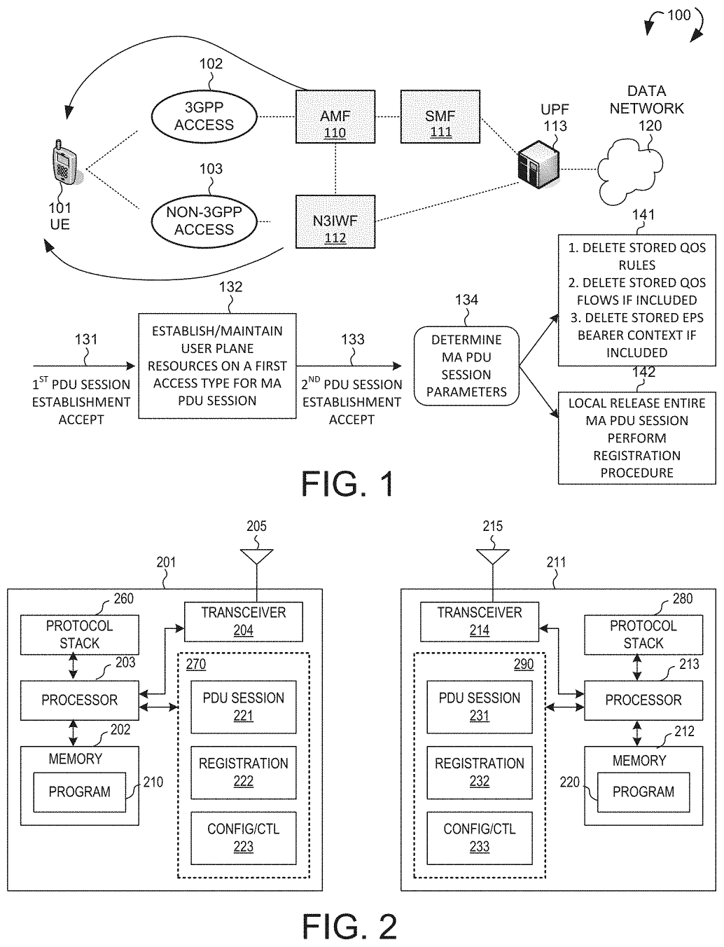

FIG. 1 illustrates an exemplary 5G network 100 supporting handling multiple accept messages for a Multi-Access Protocol Data Unit (MA PDU) session establishment in accordance with one novel aspect. 5G network 100 comprises a user equipment UE 101, a 3GPP radio (e.g., NR) access network RAN 102, a non-3GPP radio access network RAN 103, an Access and Mobility Management Function (AMF) 110, a Session Management Function (SMF) 111, an Non-3GPP Interworking Function (N3IWF) 112, a User Plane Function (UPF) 113, and a data network 120. The AMF communicates with the base station, SMF and UPF for access and mobility management of wireless access devices in mobile communication network 100. The SMF is primarily responsible for interacting with the decoupled data plane, creating, updating and removing Protocol Data Unit (PDU) sessions and managing session context with the UPF. The N3IWF functionality interfaces to 5G core network control plane functions, responsible for routing messages outside 5G RAN.

In Access Stratum (AS) layer, RAN provides radio access for UE 101 via a radio access technology (RAT). In Non-Access Stratum (NAS) layer, AMF and SMF communicate with RAN and 5GC for access and mobility management and PDU session management of wireless access devices in 5G network 100. 3GPP Radio access network RAN 102 may include base stations (gNBs) providing radio access for UE 101 via various 3GPP RATs including 5G, 4G, and 3G/2G. Non-3GPP radio access network RAN 103 may include access points (APs) providing radio access for UE 101 via non-3GPP including WiFi. UE 101 can obtain access to data network 120 through 3GPP access 102, AMF 110, SMF 111, and UPF 113. UE 101 can obtain access to data network 120 through non-3GPP access 103, N3IWF 112, AMF 110, SMF 111, and UPF 113. UE 101 may be equipped with a single radio frequency (RF) module or transceiver or multiple RF modules or transceivers for services via different RATs/CNs. UE 101 may be a smart phone, a wearable device, an Internet of Things (IoT) device, a tablet, etc.

5GS networks are packet-switched (PS) Internet Protocol (IP) networks. This means that the networks deliver all traffic in IP packets, and provide users with Always-On IP Connectivity. When UE joins an EPS network, a Packet Data Network (PDN) address (i.e., the one that can be used on the PDN) is assigned to the UE for its connection to the PDN. In 4G, EPS has defined a Default EPS Bearer to provide the IP Connectivity that is Always-On. In 5G, a Protocol Data Unit (PDU) session establishment procedure is a parallel procedure of a PDN connection procedure in 4G. A PDU session defines the association between the UE and the data network that provides a PDU connectivity service. Each PDU session is identified by a PDU session ID (PSI), and may include multiple QoS flows and QoS rules.

Each PDU session can be established over a 3GPP RAN, or over a non-3GPP RAN for radio access. 5G Session management (5GSM) for PDU sessions over both 3GPP access and non-3GPP access are managed by AMF and SMF via NAS signaling. Operators are seeking ways to balance data traffic between mobile networks and non 3GPP access in a way that is transparent to users and reduces mobile network congestion. In 5GS, UEs that can be simultaneously connected to both 3GPP access and non-3GPP access (using 3GPP NAS signalling), thus the 5GS is able to take advantage of these multiple accesses to improve the user experience, optimize the traffic distribution across various accesses. Accordingly, 3GPP introduced Multi-Access (MA) PDU session in 5GS. A MA PDU session uses one 3GPP access network or one non-3GPP access network at a time, or simultaneously one 3GPP access network and one non-3GPP access network. In addition, the UE and the network can support Access Traffic Steering Switching and Splitting (ATSSS) functionalities to distribute traffic over 3GPP access and non-3GPP access for the established MA PDU session.

For an MA PDU session establishment, if the UE is registered over both 3GPP access and non-3GPP access in different PLMNs, then the UE shall initiate the UE-requested PDU session establishment procedure over 3GPP access and non-3GPP access sequentially. Therefore, it is possible that the UE may receive more than one PDU SESSION ESTABLISHMENT ACCEPT messages during the life time of an MA PDU session. For example, the UK may receive two PDU SESSION ESTABLISHMENT ACCEPT messages including the ATSSS container IE over 3GPP access and non-3GPP access. It is undefined on the UE handling upon receiving the multiple ATSSS container IEs during the PDU session establishment for the same MA PDU.

In accordance with one novel aspect, a method of handling multiple PDU SESSION ESTABLISHMENT ACCEPT messages for establishing an MA PDU session is proposed. UE 101 receives a first PDU SESSION ESTABLISHMENT ACCEPT message over one access type for an MA PDU (step 131). User plane resources over the access type is established for the MA PDU (step 132). UE 101 then receives a second PDU SESSION ESTABLISHMENT ACCEPT message over another access type for the MA PDU (step 133). UE 101 determines MA PDU session parameters carried by the second accept message (step 134). In one novel aspect, in step 141, for an MA PDU session already established on a single access, upon receipt of PDU SESSION ESTABLISHMENT ACCEPT message over the other access, UE 101 1) deletes the stored authorized QoS rules; 2) deletes the stored authorized QoS flow descriptions if the authorized QoS flow descriptions IE is included in the PDU SESSION ESTABLISHMENT ACCEPT message; and 3) deletes the stored mapped EPS bearer contexts if the mapped EPS bearer contexts IE is included in the PDU SESSION ESTABLISHMENT ACCEPT message. In another novel aspect, in step 142, for an MA PDU session already established on a single access, upon receipt of a PDU SESSION ESTABLISHMENT ACCEPT message over the other access, UE 101 performs a local release of the MA PDU session if any value of the selected PDU session type, selected SSC mode, 5GSM cause, PDU address, S-NSSAI, DNN IEs in the PDU SESSION ESTABLISHMENT ACCEPT message is different from the corresponding stored value. UE 101 also performs a registration procedure for mobility and periodic registration update with REGISTRATION REQUEST messages including a PDU session status IE that is sent over both accesses.

FIG. 2 illustrates simplified block diagrams of wireless devices, e.g., a UE 201 and a network entity 211 in accordance with embodiments of the current invention. Network entity 211 may be a base station and/or an AMF/SMF. Network entity 211 has an antenna 215, which transmits and receives radio signals. A radio frequency RF transceiver module 214, coupled with the antenna, receives RF signals from antenna 215, converts them to baseband signals and sends them to processor 213. RF transceiver 214 also converts received baseband signals from processor 213, converts them to RF signals, and sends out to antenna 215. Processor 213 processes the received baseband signals and invokes different functional modules to perform features in base station 211. Memory 212 stores program instructions and data 220 to control the operations of base station 211. In the example of FIG. 2, network entity 211 also includes protocol stack 280 and a set of control functional modules and circuitry 290.

Similarly, UE 201 has memory 202, a processor 203, and radio frequency (RF) transceiver module 204. RF transceiver 204 is coupled with antenna 205, receives RF signals from antenna 205, converts them to baseband signals, and sends them to processor 203. RF transceiver 204 also converts received baseband signals from processor 203, converts them to RF signals, and sends out to antenna 205. Processor 203 processes the received baseband signals and invokes different functional modules and circuits to perform features in UE 201. Memory 202 stores data and program instructions 210 to be executed by the processor to control the operations of UE 201. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines. A processor in associated with software may be used to implement and configure features of UE 201.

UE 201 also comprises a set of functional modules and control circuitry to carry out functional tasks of UE 201. Protocol stacks 260 comprise Non-Access-Stratum (NAS) layer to communicate with an AMF/SMF/MME entity connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. System modules and circuitry 270 may be implemented and configured by software, firmware, hardware, and/or combination thereof. The function modules and circuits, when executed by the processors via program instructions contained in the memory, interwork with each other to allow UE 201 to perform embodiments and functional tasks and features in the network.

In one example, system modules and circuits 270 comprise PDU session handling circuit 221 that performs PDU session establishment and modification procedures with the network, a registration handling circuit 222 that performs registration with the network via 3GPP or non-3GPP access, and a config and control circuit 223 that handles configuration and control parameters for mobility management and session management. In one example, upon receipt of a second PDU SESSION ESTABLISHMENT ACCEPT message over the other access, the UE deletes the stored authorized QoS rules, and deletes the stored authorized QoS flow descriptions and the stored mapped EPS bearer contexts if they are included in the PDU SESSION ESTABLISHMENT ACCEPT message. In another example, upon receipt of a second PDU SESSION ESTABLISHMENT ACCEPT message over the other access, the UE performs a local release of the MA PDU session if any value of the selected PDU session type, selected SSC mode, 5GSM cause, PDU address, S-NSSAI, DNN IEs in the PDU SESSION ESTABLISHMENT ACCEPT message is different from the corresponding stored value.

An MA PDU session in 5GS can be established after a UE is registered to the network over both 3GPP and non-3GPP access type belonging to the same PLMN. The UE establishes a MA PDU session by initiating a PDU session establishment procedure with the network over either 3GPP or non-3GPP access type and activating the MA PDU session in a single step. The activation of the MA PDU connectivity service refers to the establishment of user-plane resources on both 3GPP access and non-3GPP access. In another embodiment, the UE is registered to the network over both 3GPP and non-3GPP access type belonging to different PLMNs. The MA PDU session is first established over one access type and then established over another access type in two separate steps. In yet another embodiment, the UE registers to the network over 3GPP access and non-3GPP access type belonging to the same PLMN and establishes the MA PDU session to the same PLMN over both 3GPP access type and non-3GPP access type in two separate steps.

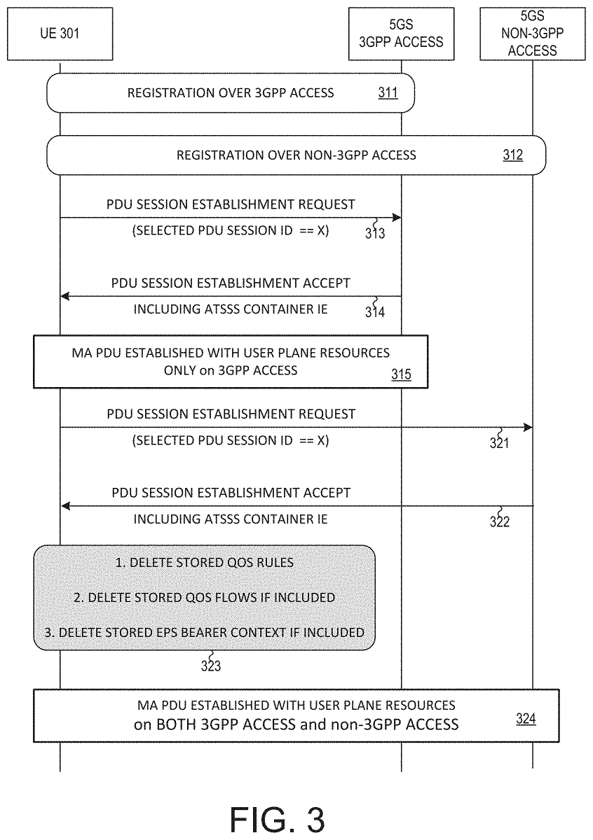

FIG. 3 illustrates a first embodiment of handling a second accept message by a UE for an MA PDU session establishment. In step 311, UE 301 performs registration with the 5GS network over 3GPP access. In step 312, UE 301 performs registration with the 5GS network over non-3GPP access. In step 313, UE 301 sends a first PDU SESSION ESTABLISHMENT REQUEST message to 5GS over 3GPP access, indicating a PDU session ID==x, and a Request type==MA PDU. In step 314, UE 301 receives a first PDU SESSION ESTABLISHMENT ACCEPT message from 5GS over 3GPP access, the accept message includes ATSSS container IE, and includes MA PDU session parameters, e.g., authorized QoS rules, authorized QoS flow descriptors, and mapped EPS bearer contexts. UE 301 stores corresponding parameters. In step 315, the MA PDU session (PSI=x) with user plane resources are established only on 3GPP access.

In step 321, UE 301 sends another PDU SESSION ESTABLISHMENT REQUEST message to 5GS over non-3GPP access, indicating a PDU session ID==x, and a Request type==MA PDU for the same MA PDU session. In step 322, UE 301 receives a second PDU SESSION ESTABLISHMENT ACCEPT message from 5GS over non-3GPP access for the same MA PDU session, the second accept message includes ATSSS container IE, and includes MA PDU session parameters, e.g., authorized QoS rules, authorized QoS flow descriptors, and mapped EPS bearer contexts. However, the newly provided MA PDU session parameters may not work together with the existing parameters stored at the UE side. For example, the same MA PDU session cannot have different conflicting QoS rules. Accordingly, UE 301 should delete the existing stored parameters such that the MA PDU session can function properly. In step 323, UE 301 1) deletes the stored authorized QoS rules; 2) deletes the stored authorized QoS flow descriptions if the authorized QoS flow descriptions IE is included in the second PDU SESSION ESTABLISHMENT ACCEPT message; and 3) deletes the stored mapped EPS bearer contexts if the mapped EPS bearer contexts IE is included in the second PDU SESSION ESTABLISHMENT ACCEPT message. In step 324, the MA PDU session with PSI=x is established, with user plane resources being established on both 3GPP access and non-3GPP access.

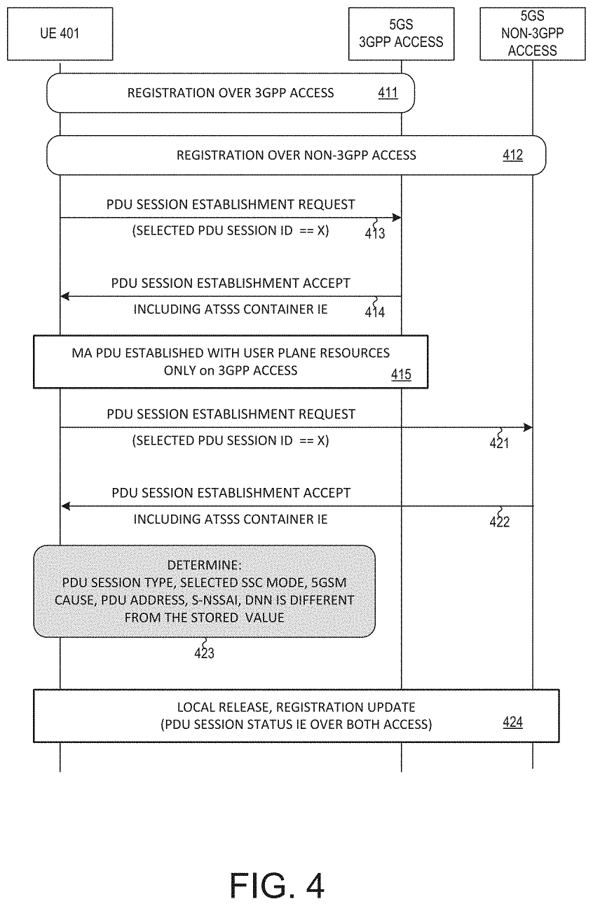

FIG. 4 illustrates a second embodiment of handling a second accept message by a UE for an MA PDU session establishment. Step 411 to step 415 of FIG. 4 are similar to step 311 to step 315 of FIG. 3, where UE 401 establishes a MA PDU session with PSI=x, and user plane resources are established only on 3GPP access. UE stores MA PDU session parameters including selected PDU session type, selected SSC mode, 5GSM cause, PDU address, S-NSSAI, and DNN IE. In step 421, UE 401 sends another PDU SESSION ESTABLISHMENT REQUEST message to 5GS over non-3GPP access, indicating a PDU session ID==x, and a Request type==MA PDU for the same MA PDU session. In step 422, UE 401 receives a second PDU SESSION ESTABLISHMENT ACCEPT message over non-3GPP access from 5GS for the same MA PDU session. The second accept message includes ATSSS container IE, and includes MA PDU session parameters, e.g., selected PDU session type, selected SSC mode, 5GSM cause, PDU address, S-NSSAI, and DNN IE.

In step 423, UE 401 determines whether at least one of the following parameters carried by the second accept message is different from the stored value: selected PDU session type, selected SSC mode, 5GSM cause, PDU address, S-NSSAI, and DNN IE. If the answer is yes, then the MA PDU session may not function properly. For example, the same MA PDU session cannot have different PDU addresses. Thus, in step 424, UE 401 locally releases the MA PDU session on both access types, e.g., user plane resources at the UE side are released on both access types. In addition, UE 401 performs a registration procedure for mobility and periodic registration update by sending REGISTRATION REQUEST messages including PDU session status IE to the network over both accesses. Specifically, two PDU session status IEs are sent to 5GS over both accesses to indicate to the network that the entire MA PDU session on both accesses is released at the UE side. Note that two PDU session status IEs need to be sent over 3GPP and non-3GPP accesses independently, in order to synchronize the MA PDU session status with the network. In addition, the two PDU session status IEs can be sent sequentially in any order, or be sent simultaneously.

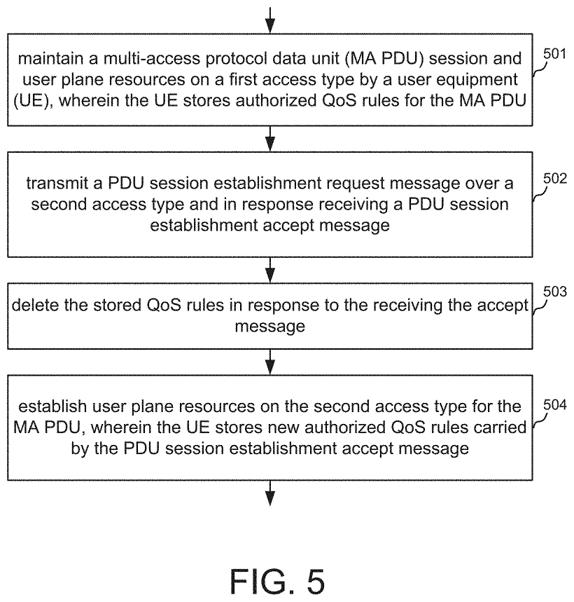

FIG. 5 is a flow chart of a method of handling multi-access (MA) Protocol data unit (PDU) session establishment with multiple accept messages in accordance with one novel aspect. In step 501, a UE maintains a multi-access protocol data unit (MA PDU) session and user plane resources on a first access type. The UE stores authorized QoS rules for the MA PDU session. In step 502, the UE transmits a PDU session establishment request message over a second access type and in response receiving a PDU session establishment accept message. In step 503, the UE deletes the stored QoS rules in response to the receiving the accept message. In step 504, the UE establishes user plane resources on the second access type for the MA PDU, wherein the UE stores new authorized QoS rules carried by the PDU session establishment accept message.

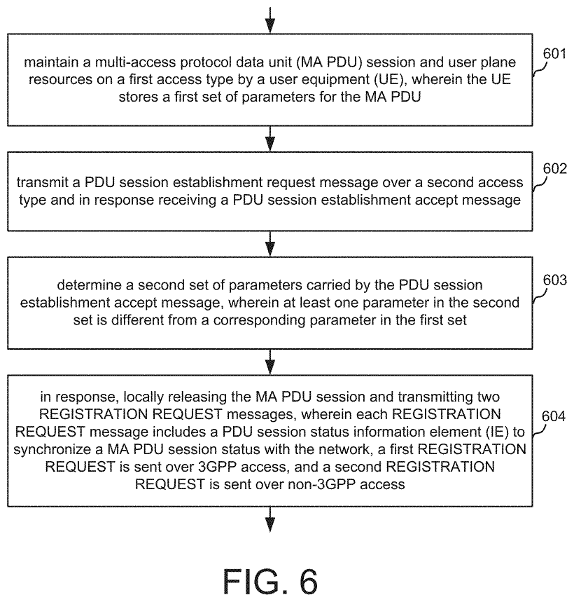

FIG. 6 is a flow chart of a method of handling multi-access (MA) Protocol data unit (PDU) session establishment with multiple accept messages in accordance with one novel aspect. In step 601, a UE maintains a multi-access protocol data unit (MA PDU) session and user plane resources on a first access type. The UE stores a first set of parameters for the MA PDU. In step 602, the UE transmits a PDU session establishment request message over a second access type and in response receiving a PDU session establishment accept message. In step 603, the UE determines a second set of parameters carried by the PDU session establishment accept message, wherein at least one parameter in the second set is different from a corresponding parameter in the first set. In response, in step 604, the UE locally releases the MA PDU session and transmitting two REGISTRATION REQUEST messages. Each REGISTRATION REQUEST message includes a PDU session status information element (IE) to synchronize a MA PDU session status with the network, a first REGISTRATION REQUEST is sent over 3GPP access, and a second REGISTRATION REQUEST is sent over non-3GPP access.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
maintaining a multi-access protocol data unit (MA PDU) session and user plane resources on a first access type by a user equipment (UE), wherein the UE stores authorized QoS rules for the MA PDU session;
transmitting a PDU session establishment request message over a second access type and in response receiving a PDU session establishment accept message;
deleting the stored QoS rules in response to the receiving the accept message; and
establishing user plane resources on the second access type for the MA PDU, wherein the UE stores new authorized QoS rules carried by the PDU session establishment accept message.

2. The method of claim 1, wherein the PDU session establishment accept message comprises an Access Traffic Steering Switching and Splitting (ATSSS) Container IE.

3. The method of claim 1, wherein the PDU session establishment accept message comprises an authorized QoS flow description IE, and wherein the UE deletes stored authorized QoS flow descriptions.

4. The method of claim 1, wherein the PDU session establishment accept message comprises a mapped EPS bearer context IE, and wherein the UE deletes stored mapped EPS bearer contexts.

5. The method of claim 1, wherein the PDU session establishment accept message is a second PDU session establishment accept message received by the UE over the second access type for the MA PDU session.

6. The method of claim 1, wherein the stored authorized QoS rules is included in a first PDU session establishment accept message received by the UE over the first access type for the same MA PDU session.

7. A method, comprising:
maintaining a multi-access protocol data unit (MA PDU) session and user plane resources on a first access type by a user equipment (UE), wherein the UE stores a first set of parameters for the MA PDU;
transmitting a PDU session establishment request message over a second access type and in response receiving a PDU session establishment accept message;
determining a second set of parameters carried by the PDU session establishment accept message, wherein at least one parameter in the second set is different from a corresponding parameter in the first set; and
in response, locally releasing the MA PDU session and transmitting two REGISTRATION REQUEST messages, wherein each REGISTRATION REQUEST message includes a PDU session status information element (IE) to synchronize a MA PDU session status with the network, a first REGISTRATION REQUEST is sent over 3GPP access, and a second REGISTRATION REQUEST is sent over non-3GPP access.

8. The method of claim 7, wherein the first and the second set of parameters each comprises a PDU session type, a selected session and service continuity (SSC) mode, a 5G session management (5GSM) cause, a PDU address, a Single Network Slice Selection Assistance Information (S-NSSAI), and a data network name (DNN) IE.

9. The method of claim 7, wherein the PDU session status IE sent over 3GPP access indicates that the 3GPP access user plane resources of the MA PDU session is released, and the PDU session status IE sent over non-3GPP access indicates that the non-3GPP access user plane resources of the MA PDU session is released.

10. The method of claim 7, wherein the PDU session establishment accept message is a second PDU session establishment accept message received by the UE over the second access type for the MA PDU session.

11. The method of claim 7, wherein the first set of parameters is included in a first PDU session establishment accept message received by the UE over the first access type for the same MA PDU session.

12. A user equipment (UE), comprising:
a multi-access protocol data unit (MA PDU) session handing circuit that maintains user plane resources on a first access type of an MA PDU session, wherein the UE stores a first set of parameters for the MA PDU session;
a transmitter that transmits a PDU session establishment request message over a second access type;
a receiver that receives a PDU session establishment accept message in response to the request message; and
a controller that determines a second set of parameters carried by the PDU session establishment accept message, wherein at least one parameter in the second set is different from a corresponding parameter in the first set, wherein the UE locally releases the MA PDU session and transmits two REGISTRATION REQUEST messages, wherein each REGISTRATION REQUEST message includes a PDU session status information element (IE) to synchronize a MA PDU session status with the network, a first REGISTRATION REQUEST is sent over 3GPP access, and a second REGISTRATION REQUEST is sent over non-3GPP access.

13. The UE of claim 12, wherein the first and the second set of parameters each comprises a PDU session type, a selected session and service continuity (SSC) mode, a 5G session management (5GSM) cause, a PDU address, a Single Network Slice Selection Assistance Information (S-NSSAI), and a data network name (DNN) IE.

14. The UE of claim 12, wherein the PDU session status IE sent over 3GPP access indicates that the 3GPP access user plane resources of the MA PDU session is released, and the PDU session status IE sent over non-3GPP access indicates that the non-3GPP access user plane resources of the MA PDU session is released.

15. The UE of claim 12, wherein the PDU session establishment accept message is a second PDU session establishment accept message received by the UE over the second access type for the MA PDU session.

16. The UE of claim 12, wherein the first set of parameters is included in a first PDU session establishment accept message received by the UE over the first access type for the same MA PDU session.
